(19) United States
(12) Patent Application Publication
(10) Pub. No.: US 2004/0128794 A1
(43) Pub. Date: Jul. 8, 2004

(54) Adjustable hinge

(76) Inventor: Stanley Chung, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/334,976

(22) Filed: Jan. 2, 2003

(51) Int. Cl. E05D 7/04

(52) U.S. Cl. 16/236

(57) ABSTRACT

A hinge is connected between the door frame and the door and includes a mounting assembly fixed received in the door. The mounting assembly includes a casing and a piece is movably received in the casing. The door leaf is retained in a space defined in the piece. An adjustment screw extends through an opening defining through a side of the casing and a collar is threadedly mounted to threads of the adjustment screw. The collar is rotatably engaged with the door leaf so as to apply a force to the door leaf when rotating the adjustment screw. The force makes the door to be moved in horizontal direction relative to the door frame.

### FIELD OF THE INVENTION

The present invention relates to an adjustable hinge that is connected between the door and the door frame and is capable of adjusting the door relative to the door frame in three dimensional directions.

### BACKGROUND OF THE INVENTION

A conventional door hinge known to the applicant is disclosed in U.S. Pat. No. 5,339,493 to Macintyre. The adjustable hinge includes an adjustable mounting assembly that is embedded in the door and a base is movably received in the mounting assembly. The door leaf is connected to the base which can be adjusted by operating two adjustment screws. The door can be adjusted at an angle relative to the frame as shown in FIG. 4 of the disclosure of the previous mentioned patent reference and be adjusted the upper and lower positions of the door relative to the frame as shown in FIG. 3 in the disclosure. It is to be noted that the door cannot be adjusted in horizontal direction.

The present invention intends to provide a door hinge that allows the user to adjust the door in horizontal direction relative to the frame by simply rotating an adjustment screw from a side of the mounting assembly of the hinge.

### SUMMARY OF THE INVENTION

In accordance with one aspect of the present invention, there is provided a hinge which comprises a frame leaf fixedly connected to a door frame and two first sleeves are connected to the frame leaf in separate. A mounting assembly is fixedly received in a door and includes a door leaf. A second sleeve is connected to the door leaf and positioned between the two first sleeves with a pin extending through the two first sleeves and the second sleeve. The mounting assembly includes a casing and a piece is movably received in the casing. The piece has a space defined therein and an end of the door leaf movably extends through a wall of the casing and is retained in ithe space in the piece. An adjustment screw extends through an opening defining through a side of the casing and a collar is threadedly mounted to threads of the adjustment screw. The collar is rotatably engaged with the door leaf so as to apply a force to the door leaf to adjust the door in horizontal direction.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hinge connected between a door frame and a door;

FIG. 2 is a cross sectional view to show an adjustment screw contacts a top of the piece in the mounting assembly in the casing;

FIG. 3 shows two protrusions from the piece movably extending through a slot defined through a back of the casing;

FIG. 4 shows another adjustment screw with a collar mounted thereto extends into the casing and the collar contacts the door leaf, and

FIG. 5 shows that the door can be adjusted an angle relative to the door frame.

### DETAILED DESCRIPTION OF THE PREFERRED EMBODIMENT

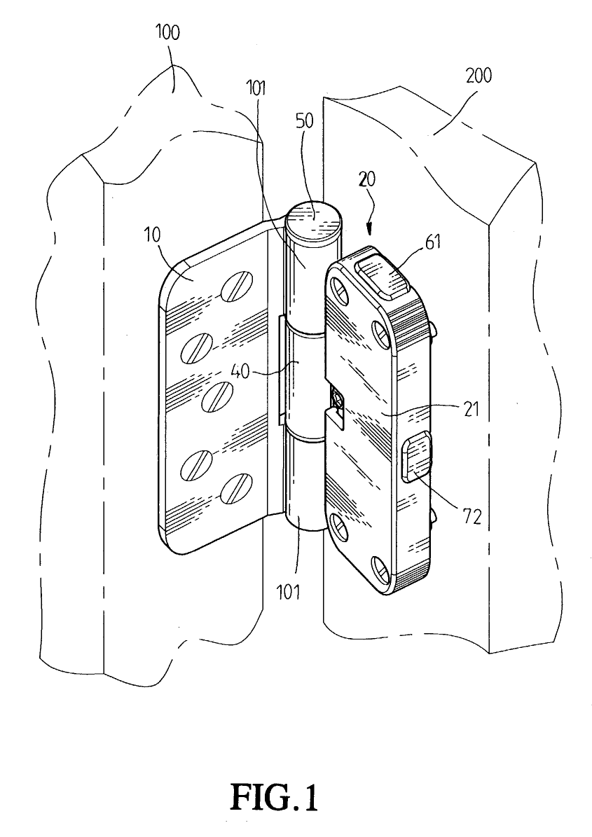

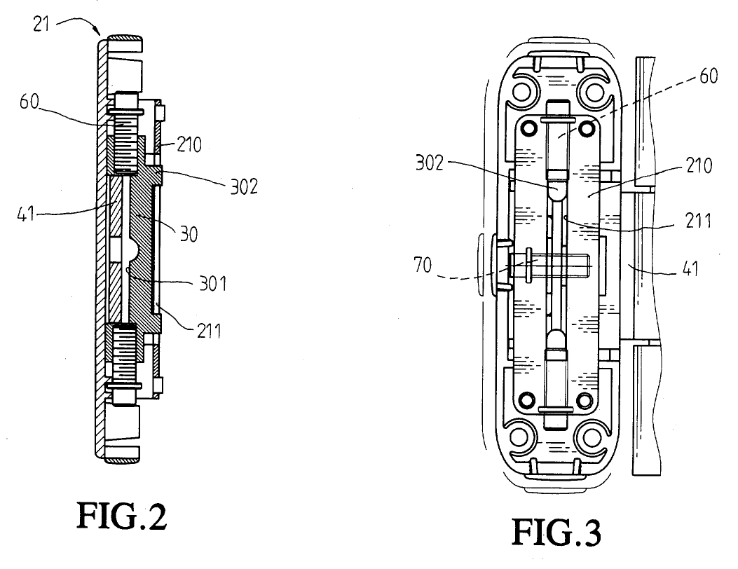

Referring to FIGS. 1 to 3, the hinge of the present invention comprises a frame leaf 10 fixedly connected to a door frame 100 and two first sleeves 101 are connected to the frame leaf 10 in separate.

A mounting assembly 20 is fixed received in a door 200 and includes a casing 21 which includes a front plate, a back 210 and four sides connected between the back 210 and the front plate. A piece 30 is movably received in the casing 21 and has a space 301 defined therein. A slot 211 is defined through the back 210 of the casing 21. A second sleeve 40 is connected to a door leaf 41 and positioned between the two first sleeves 101 with a pin 50 extending through the two first sleeves 101 and the second sleeve 40. An end of the door leaf 41 movably extends through a wall of the casing 21 and is retained in the space 301 in the piece 30. Two protrusions 302 extend from the piece 30 and movably extend through the slot 211.

An adjustment screw 60 extends through an opening defined through a top side of the casing 21 and contacts a top surface of the piece 30. A cap 61 seals the opening defined through the top side of the casing 21 and prevents dust from accessing the adjustment screw 60. Therefore, when rotating the adjustment screw 60 by a proper tool such as a wrench, the piece 30 is pushed downward and the two protrusions 302 are moved in the longitudinal slot 211 so that the movement of the piece 30 shifts the door leaf 41. Nevertheless, the door leaf 41 is fixed so that the force applied to the piece 30 makes the door 200 moved between the upper position and the lower position relative to the door frame 100.

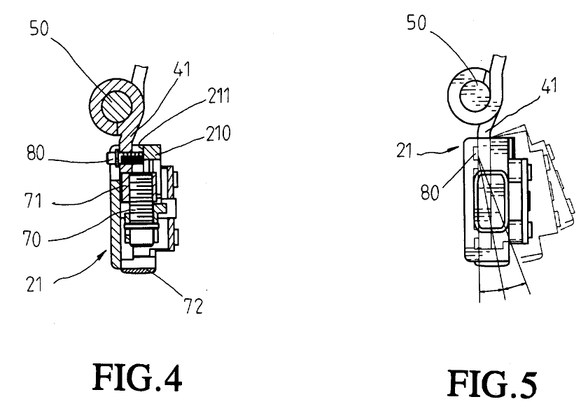

Further referring to FIG. 4, an adjustment screw 70 extends through an opening defining through a side of the casing 21 and a collar 71 is threadedly mounted to threads of the adjustment screw 70. The collar 71 is rotatably engaged with the door leaf 41 so as to apply a force to the door leaf 41. The collar 71 may be engaged with an aperture defined through the door leaf 41 so that an end of the collar 71 contacts the periphery of the aperture. A cap 72 seals the first opening in the side of the casing 21 to cover the adjustment screw 70. When the adjustment screw 70 is rotated, the collar 71 pushes the door leaf 41 such that the door 200 can be adjusted in horizontal direction relative to the door frame 100.

An adjustment screw 80 extends through the door leaf 41 and contacts against an face of the back 210 at the position of 211 in FIG. 4 of the casing 21. When the adjustment screw 80 is rotated, the casing 21 is applied a force by the adjustment screw 80 and the casing 21 together with the door 200 can be adjusted an angle as shown in FIG. 5.

The hinge of the present invention allows the user to conveniently shift the door 200 relative to the door frame 100 in horizontal direction simply by rotating the adjustment screw 70 from a side of the casing 21. In other words, the hinge of the present invention adjusts the hinge in a linear path, the vertical and the horizontal direction, and this allows the users to adjust the hinge under control and the hinge can be adjusted precisely as desired. On the contrary, the conventional hinge as disclosed in U.S. Pat. No. 5,339,493 to Macintyre, the hinge can only adjust the hinge in an elliptical or a non-linear pattern, such as a “seesaw” motion which moves the hinge in a two dimensions like a seesaw. This “seesaw” motion of the conventional hinge limits the range of adjustability of the hinge.

While we have shown and described the embodiment in accordance with the present invention, it should be clear to those skilled in the art that further embodiments may be made without departing from the scope of the present invention.

What is claimed is:

1. A hinge comprising:
a frame leaf adapted to be fixedly connected to a door frame and two first sleeves connected to the frame leaf in separate;
a mounting assembly adapted to be fixed received in a door and including a casing, a piece being movably received in the casing and having a space defined therein, a second sleeve connected to a door leaf and positioned between the two first sleeves with a pin extending through the two first sleeves and the second sleeve, an end of the door leaf movably extending through a wall of the casing and being retained in the space in the piece, and
a first adjustment screw extending through a first opening defining through a side of the casing and a collar threadedly mounted to threads of the first adjustment screw, the collar rotatably engaged with the door leaf so as to apply a force to the door leaf.

2. The hinge as claimed in claim 1 further comprising a cap sealing the first opening in the side of the casing.

3. The hinge as claimed in claim 1 further comprising a second adjustment screw extending through a second opening defined through a top of the casing and contacting a top surface of the piece, two protrusions extending from the piece and movably extending through a slot defined through a back of the casing.

4. The hinge as claimed in claim 1 further comprising a cap sealing a second opening defined through the top of the casing.

5. The hinge as claimed in claim 1 further comprising a third adjustment screw extending through the door leaf and contacting against an face of the back of the casing.
